(19) United States
(12) Patent Application Publication
(10) Pub. No.: US 2008/0174687 A1
(43) Pub. Date: Jul. 24, 2008

(54) APPARATUS AND METHOD FOR PHOTOGRAPHING

(75) Inventor: Saki SHIMIZU, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 12/016,292

(22) Filed: Jan. 18, 2008

(30) Foreign Application Priority Data
Jan. 22, 2007 (JP) 2007-011964
Dec. 26, 2007 (JP) 2007-334951

(51) Int. Cl. H04N 3/14

(52) U.S. Cl. 348/333.02; 348/E05.061

(57) ABSTRACT

An apparatus for photographing has a photographing processor that carries out a photographing process; a recording processor that records a photographic image; and a display processor that is capable of displaying a recorded photographic image. The display processor is also capable of displaying input information on an input information screen separately from the photographic image. The recording processor records the input information screen as an image. Then, the display processor displays the recorded input screen image.

### BACKGROUND OF THE INVENTION

1. Field of the Invention

The present invention relates to a photographing device such as a digital camera, or a cell phone with a photographing function. In particular, it relates to the displaying and recording of input information such as a note.

2. Description of the Related Art

In a digital camera, a recorded photographic image can be displayed on an LCD monitor. In playback mode, a series of photographic images may be displayed at the same time, or one by one. When associating a comment with a photographic image, a photographer usually drafts the comment after taking the image, using a computer. The drafted comment can be transmitted to the camera as data, and is superimposed on the photographic image.

On the other hand, in a digital camera with a touch panel, a photographer can input characters using a stylus. For example, the photographer may write a note associated with a target scene, such as the name of the subject, on the LCD monitor before photographing. Then, the photographer photographs while confirming the written note.

However, in some cases, the subjects might not be decided in advance, and the photographer might photograph immediately on encountering an adequate scene. Thus, the photographer might be not unable to associate a comment with a scene during the taking of a photograph.

### SUMMARY OF THE INVENTION

An object of the present invention is to provide an apparatus and method for photographing that is capable of recording and displaying input information such as a note while associating the input information with a photographic image.

An apparatus for photographing according to the present invention has a photographing processor that carries out a photographing process; a recording processor that records a photographic image; and a display processor that is capable of displaying a recorded photographic image. The display processor is also capable of displaying input information on a screen (herein, called “input information screen”) separately from the photographic image.

For example, an input device such as a touch panel is provided. In this case, the display processor displays input information on the input information screen in accordance with an input operation. To input characters or drawings while a photographing is taken, a mode change processor that changes a photographing mode to an input mode may be provided. The display processor displays input information on the input information screen in the input mode.

In the present invention, the recording processor records the input information screen as an image. Then, the display processor displays the recorded image of input information screen (herein, called “input screen image”). For example, the display processor displays the recorded input information image and the photographic image in playback mode. Since the input information is recorded as an image, the user can input a note freely, and the input note can be recorded while associating the input note with photographic images. For example, the display processor displays a series of recorded input information images and photographic images according to the recording order of the images. Also, the recording processor may record input information images and the photographic images by using a compressing process. The photographing processor may carry out a process performed in a playback mode while the input information is displayed. For example, in the case of a camera, a photographing optical system is retracted into a camera body.

The display processor may display only recorded input information images simultaneously or sequentially. For example, a mode change processor that changes a playback mode to an input mode is provided. In this case, the recording processor may associate an input information screen to be recorded with a photographic image, just before changing from the playback mode to the input mode. The display processor may display the input information screen and the associated photographic image alternately. For example, the displaying processor displays an input information screen and a related photographic image in a child window and a parent screen, respectively, and switches between the child window and the parent screen.

The recording processor may generate a folder that stores an input information screen when recording the input information screen. Also, a recording order change processor that changes the recording order of recorded input information screens may be provided. Further, a data-transmitting processor that transmits only the data of the photographic images to an external location may be provided.

A method for photographing according to another aspect of the present invention includes: a) recording a photographic image; b) displaying a recorded photographic image; c) displaying input information on an input information screen separately from the photographic image; d) recording the input information screen as an image; and e) displaying the recorded input information images.

### BRIEF DESCRIPTION OF THE DRAWINGS

The present invention will be better understood from the description of the preferred embodiments of the invention set forth below together with the accompanying drawings, in which:

FIG. 1 is a block diagram of a digital camera according to the first embodiment;

FIG. 2 is a camera control process performed by the system control circuit;

FIG. 3 is a view showing a screen in the input mode;

FIG. 4 is a view showing the playback screen in the playback mode;

FIG. 5 is a flowchart of the playback display process according to the second embodiment;

FIG. 6 is a view showing the playback screen;

FIG. 7 is a flowchart of a playback process according to the third embodiment;

FIG. 8 is a view showing the addition of a note and a playback display;

FIG. 9 is a view showing a playback screen according to the fourth embodiment;

FIG. 10 is a flowchart of a playback process according to the fifth embodiment;

FIG. 11 is a view showing a folder;

FIG. 12 is a flowchart of the recording order change process according to the sixth embodiment;

FIG. 13 is a view showing the changing of a recorded note date;

FIG. 14 is a view showing the recording order alternation of the playback images; and

FIG. 15 is a flowchart of a print process according to the seventh embodiment.

### DESCRIPTION OF THE PREFERRED EMBODIMENTS

Hereinafter, the preferred embodiments of the present invention are described with reference to the attached drawings.

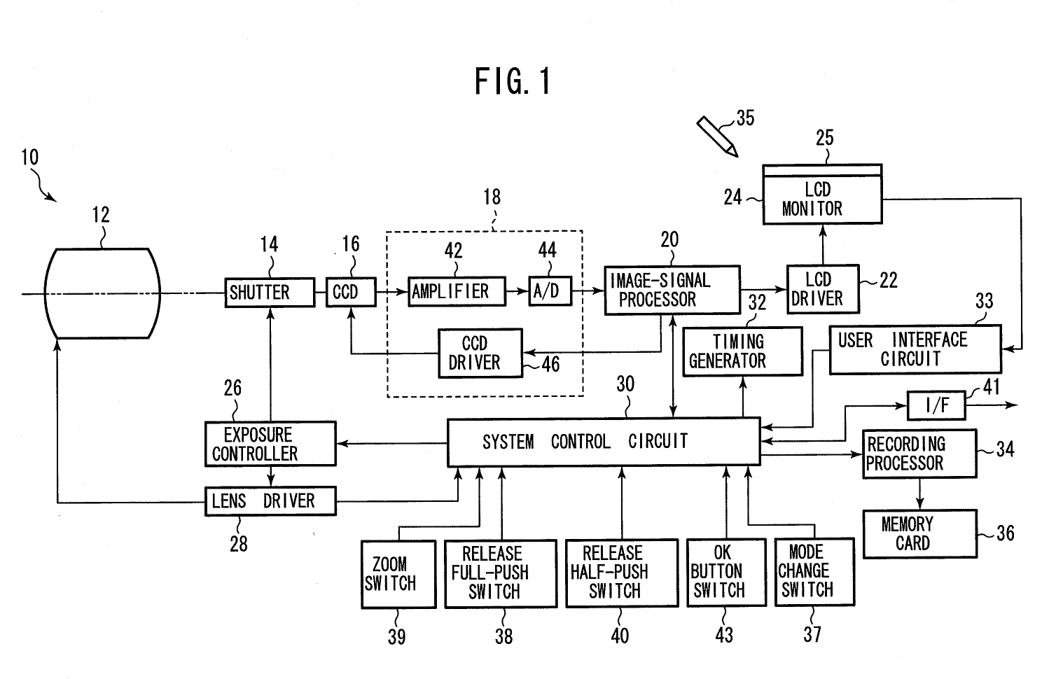

FIG. 1 is a block diagram of a digital camera according to the first embodiment.

The digital camera 10 is a compact digital camera, and a memory card 36 is removably installed into the camera 10. The camera has a system control circuit 30, which includes a CPU, a ROM unit, and a RAM unit, and controls the action of the camera 10. The system control circuit 30 connects to a zoom switch 39, a release half-push switch 40, a release full-push switch 38, and an OK button switch 43, and detects an operation signal when a release button, zoom lever, or OK button (not shown) is operated by the user.

Also, the camera 10 has a mode-change button (not shown) for switching mode between the photographing mode and the playback mode. The system control circuit 38 detects a signal from the mode-change switch 37. When a main power button (not shown) is turned on, a photographing operation can be carried out, and the system control circuit 30 controls the photographing process. The program for controlling the camera 10 is stored in the ROM.

When the photographing mode is selected, signal processing for displaying a moving image or live image is performed. An object image is formed on the light-receiving surface of a CCD 16 by light passing through a photographing optical system 12 and a shutter 14, so that analog image-pixel signals corresponding to the object image are generated in the CCD 16. The generated image-pixel signals are successively read from the CCD 16 at constant intervals (e.g., 1/60^{th}-second intervals), and fed to an analog front end (AFE) circuit 18.

In the present embodiment, anon-chip color filter method using one color filter is applied. On the light-receiving area of the CCD16, a primary color filter, checkered by Red (R), Green (G), and Blue (B) color elements is arranged such that each area of the three color elements is opposite a pixel.

The AFE circuit 18 has an amplifier 42, an A/D converter 44, and a CCD driver 46. The CCD driver 46 outputs clock pulse signals to the CCD 16 to successively read the image-pixel signals from the CCD 16. The read image-pixel signals are amplified in the amplifier 42, and are converted to digital image signals in the A/D converter 44.

In the image-signal processor 20, various processes, such as a white-balance adjustment and a gamma-correction process, are performed on the digital image signals. The processed image signals are temporarily stored in a frame memory (not shown), and are fed to an LCD driver 22. The LCD driver 24 drives an LCD monitor 24, provided on the back surface of the camera 10, on the basis of the image signals. Thus, a moving image is displayed on the LCD monitor 24. A timing generator 32 outputs clock-pulse signals for synchronizing the timing of signal processes in the camera 10.

While displaying a moving image, a focusing controller (not shown) detects the focus condition of a subject, and outputs a control signal to the lens driver 28, so that the focusing lens in the photographing optical system 12 is driven by a lens driver 28 and brings the subject into focus. Also, when the zoom lever is operated by a user while displaying the moving image, an exposure controller 26 outputs a control signal to the lens driver 28 so that the zoom lens in the photographing optical system 12 is driven. The focusing lens is driven accordingly.

When the release button is depressed halfway and the release half-push switch 40 is turned ON, the brightness of the subject and the distance between the subject and the camera 10 are detected in an exposure detector (not shown). Furthermore, an exposure value is calculated in the exposure controller 26. When the release button is fully depressed and the release full-push switch 38 is turned ON, the photographing process to record a still image is carried out. Namely, the shutter 14 opens for a determined period by a driving signal from the exposure controller 26. Thus, one frame's worth of image-pixel signals corresponding to a single still image are read from the CCD 16, and fed to the image-signal processor 20 via the AFE circuit 18.

The one frame's worth of image-signals is subjected to processing in the image-signal processor 20, so that a single digital image is generated and temporarily stored in the frame memory. In the recording processor 34, the digital image data is then compressed in accordance with a compression standard such as JPEG, and the compressed image data is recorded in the memory card 36.

A resistive touch screen 25, in which opposing matrix electrodes are arranged between touch registers, completely covers the LCD monitor 24. In the present embodiment, the photographing mode can be changed to an input mode by the user's touch operation. In the input mode, an input operation using the user's finger or a stylus 35 is allowed. Furthermore, a series of marks for mode change, photographing condition change, etc. is displayed on the LCD monitor 24. When a user pushes a given mark, the process associated with the pushed mark is carried out.

The user interface circuit 33 detects the location of a touch on the touch screen 25. When the user writes characters, or draws on the touch screen 25 using the stylus 35, the user interface circuit 33 detects the trace of input operation. The system control circuit 30 outputs a control signal to the image-signal processor 20. Thus, input data is temporarily stored in the frame memory of the image-signal processor 20, and characters or drawings, such as a note, are displayed on the written or drawn area of the LCD monitor 24. Input data is updated and is stored in the frame memory every time a user writes new characters or draws on the touch screen 25. Then, as will be described later, input information is recorded as image data in the memory card 36.

In the playback mode, a recorded photographic image is displayed on the LCD monitor 24. Photographic image data is read from the memory card 36, and is subjected to an expansion process. The restored image data is fed to the image signal processor 20 so that the recorded photographic image is displayed on the LCD monitor 24. Furthermore, as will be described later, input information can also be displayed on the LCD monitor 24. During the playback mode, the lens barrel is retracted to the camera body, and the CCD 16 is suspended. Note that during playback mode, characters or designs can be written on the displayed photographic image. The playback mode is switched to the drawing mode by a user's touch operation, and characters or designs are superimposed on the photographic image.

An interface circuit 41 allows the camera 10 to transmit data to peripheral equipment such as a printer. When a given touch operation is performed by the user, image data is transmitted to the peripheral equipment via a signal cable.

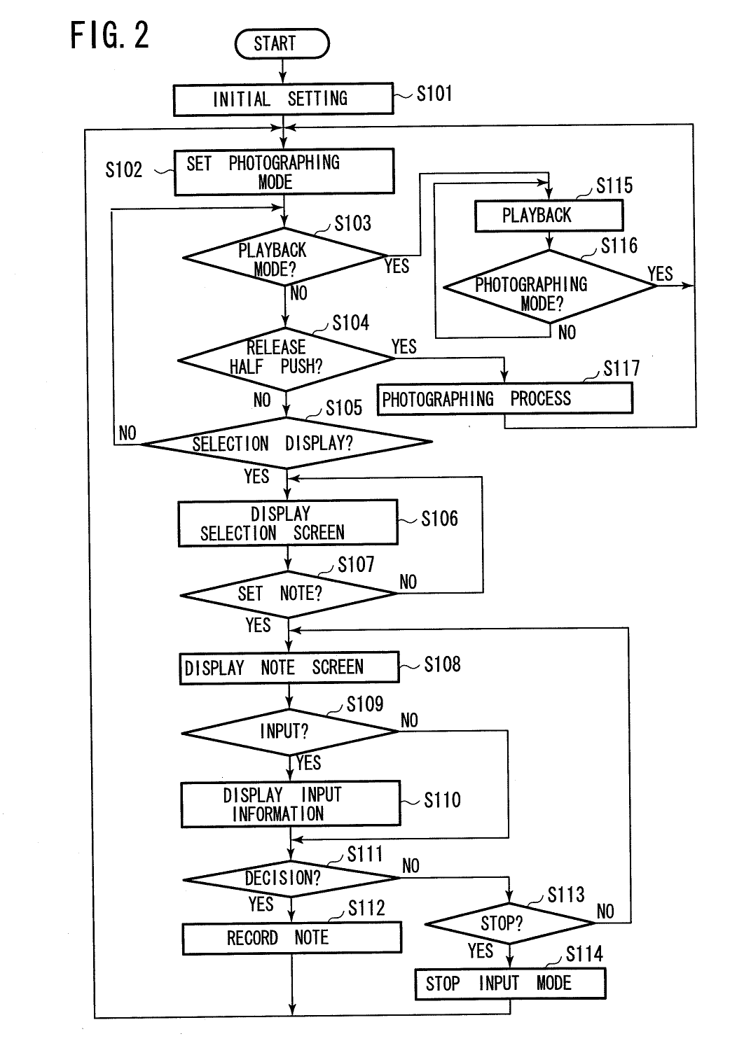

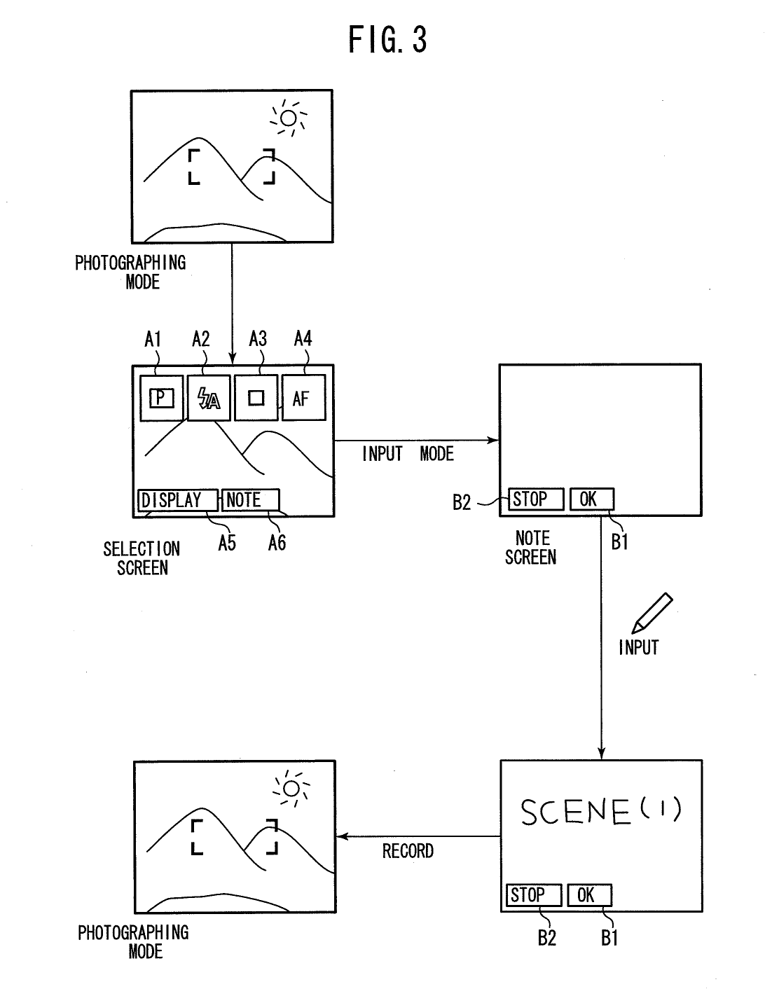

FIG. 2 is a camera control process performed by the system control circuit 30. FIG. 3 is a view showing a screen in the input mode. With reference to FIGS. 2 and 3, the note information recording process and the display process are explained. When electric power is turned ON, the process is started.

In Step S101, an initial setting is carried out on the CCD 16, shutter 14, and each signal circuit. In Step S102, the photographing mode is set so that the photographing optical system 12 extends with the lens barrel, and a moving image is displayed on the LCD monitor 24. In the present embodiment, the photographing mode is set at the same time that electric power is turned ON.

In Step S103, it is determined whether the mode-change button has been operated to switch the photographing mode to the playback mode. When it is determined that the mode-change button has been operated, the process goes to Step S115, wherein the playback mode is set and the playback display process is carried out. Namely, compressed image data is expanded, and a selected image is displayed on the LCD monitor 24.

In Step S116, it is determined whether the playback mode has been switched to the photographing mode. If it is determined that the playback mode has not been switched to the photographing mode, the process returns to Step S115. On the other hand, if it is determined that the playback mode has been switched to the photographing mode, the process returns to Step S102.

When it is determined that the mode-change button has not been operated, the process goes to Step S104, wherein it is determined whether the release button is depressed halfway. When it is determined that the release button is depressed halfway, the process goes to Step S117, in which the photographing process is performed so that the photographic image is recorded in the memory card 36. Image data is written on the memory card 36 as an image file. As for the format of the image file, a header, which includes a tag representing control information, time and date data marking a recording time, and an offset value, is added to the compressed image data.

When it is determined at Step S104 that the release button is not depressed, the process goes to Step S105. In Step S205, it is determined whether the operation for displaying a selection screen has been performed by the user. In the selection screen, the photographing method can be changed, and further, the input mode can be selected. Herein, the selection screen is displayed when a user touches a given spot on the touch screen 25.

When it is determined the operation for displaying the selection screen has been performed by the user, the process goes to Step S106, and the selection screen is displayed. As shown in FIG. 3, marks A1 to A6 are super imposed on the displayed photographic image. The marks A1 to A5 are for selecting and changing the photographing condition, such as the strobe method, focusing method, etc. The mark A6 is for switching from the photographing mode to the input mode. When the mark A6 is touched, the input mode is set.

In Step S107, it is determined whether the mark A6 has been touched by the user. When it is determined that the mark A6 has been touched, the process goes to Step S108. Note, when another mark has been touched, the process corresponding to the touched mark is carried out.

In Step S108, an exclusive note screen for writing characters or drawing on the LCD monitor 24 is displayed (see FIG. 3). In the note screen, no photographic image is displayed. The whole screen is white, and characters and drawings written with the stylus 35 are displayed in a black. Thus, the user may write characters or drawings on the LCD monitor 24 just as if the writing in a notebook. While the note screen is displayed, the lens barrel is retracted into the camera body, and the CCD 16 is suspended, similarly to the playback mode. Consequently, a photographing process cannot be carried out, and the consumption of electric power is saved.

In Step S109, it is determined whether an input operation using the stylus 35 has been carried out by the user. The user writes contents associated with a photographic image, such as the photographing location, photographing conditions, or target scene, on the LCD monitor 24. When it is determined that the input operation has been carried out, the process goes to Step S110, in which the input contents are displayed on the LCD monitor 24 (see FIG. 3).

In Step S111, it is determined whether a touch operation for deciding to store the note has been carried out. On the note screen, a mark B1, indicating the decision to store, and a mark B2, indicating the cancellation of input, are displayed on the LCD monitor 24. When it is determined that the mark B1 has not been touched, the process returns to Step S113, in which it is determined whether the mark B2 has been touched. When it is determined that the mark B2 has been touched, the input mode is finished (S114), and the photographing mode is set again.

On the other hand, when it is determined at Step S111 that the mark B1 has been touched, the process goes to Step S112. In Step S112, information input by the user is recorded as image data. Namely, the whole screen displayed on the LCD monitor 24 is directly recorded as an image. This image, temporarily stored in the frame memory of the image signal processor 20, is compressed at a predetermined compression rate, which is greater than that of the photographic image. Since the resolution required for the note may be low compared to that of the photographic image, the input screen image is compressed at a constant compression rate regardless of the data size of the photographic image. Then, the complete image file, including a header and the compressed input screen image data, is generated and stored in the memory card 36. Note that the marks B1 and B2, displayed on the LCD monitor 24 in the input mode, are not recorded.

After the note is recorded as image data, the process returns to Step S102, in which the photographing mode is set. Steps S102 to S114 are repeatedly performed until electric power is turned OFF.

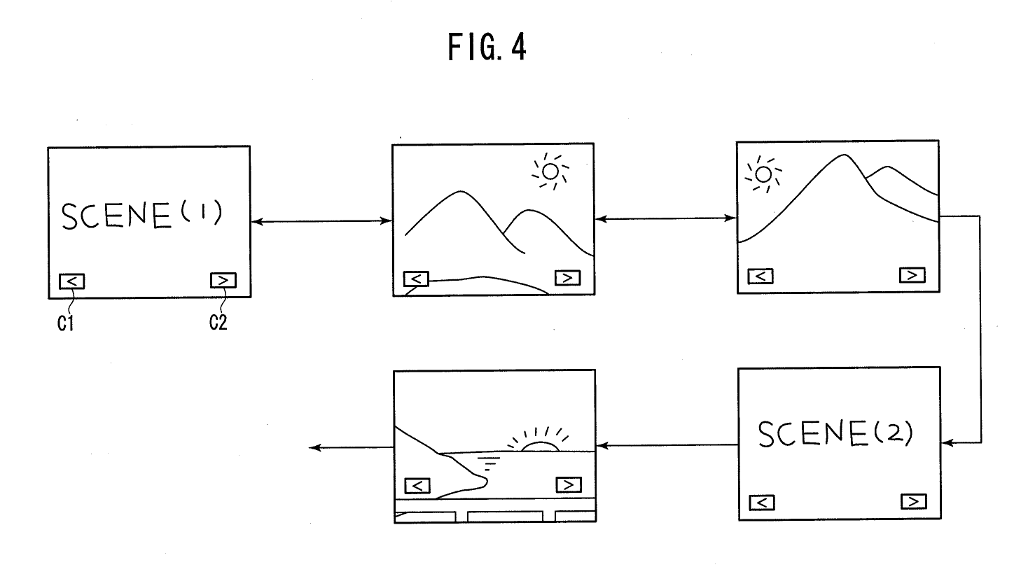

FIG. 4 is a view showing the playback screen in the playback mode.

Data associated with the recording date are stored in the header of the image file. Then, a series of image files, composed of the photographic image files tighter with the written note image files, are ordered according to the recording date. Thus, the recorded notes are displayed between recorded photographic images. As shown in FIG. 4, the image to be displayed is selected by touching marks C1 or C2. In the illustration, two notes have been recorded before photographs were taken.

Thus, in the present embodiment, the photographing mode is switched to the input mode, so the user may input characters on the exclusive input screen, and those input characters are displayed. Then, the input contents are recorded as a picture. Since the screen is dedicated to user, the user may write or draw freely. Also, since the input mode can be switched into from the photographing mode, the user may write comments spontaneously. Furthermore, since the note is recorded as image data and is displayed with the photographic images during playback mode, the user may view photographic images while associating the images with the recorded notes.

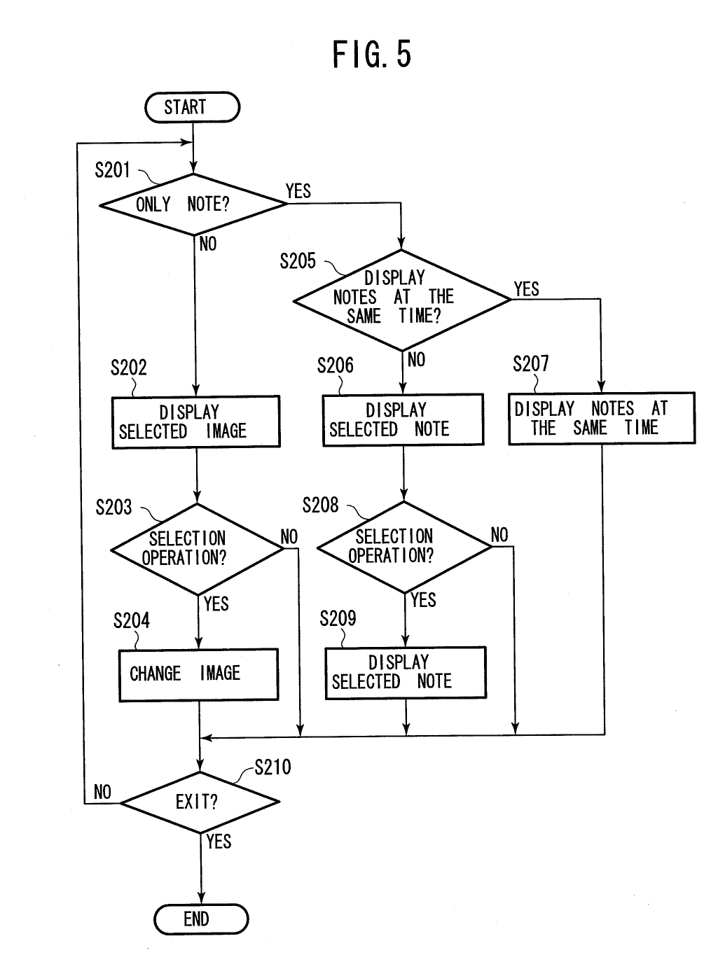

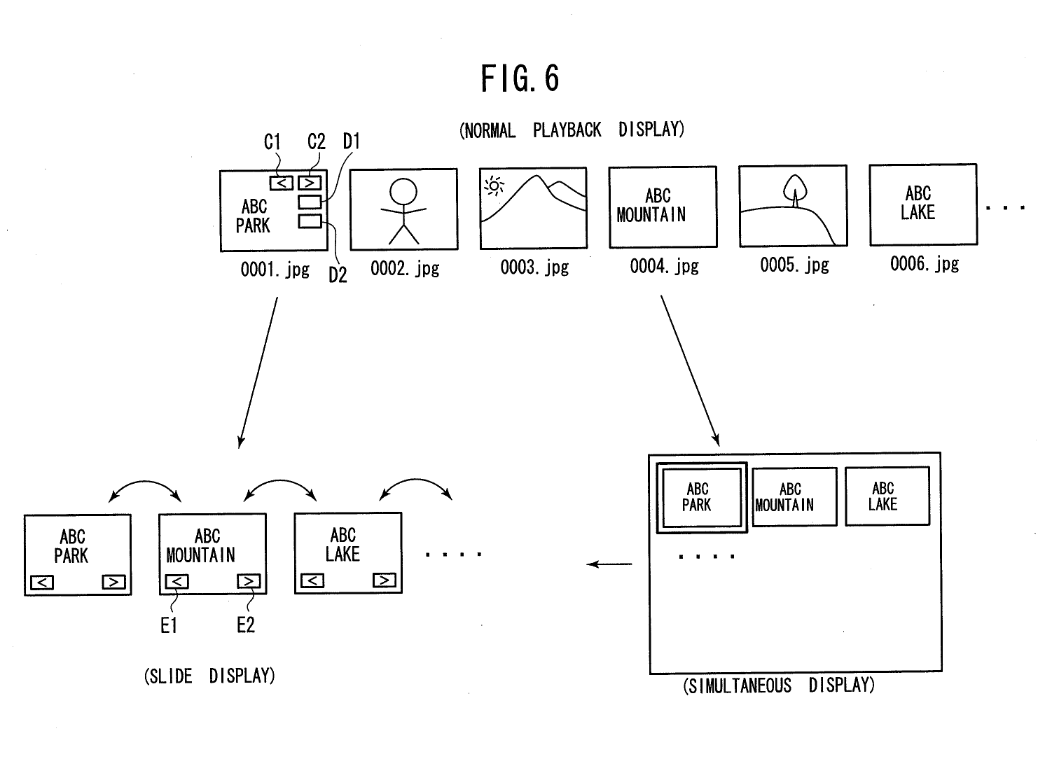

FIG. 5 is a flowchart of the playback display process according to the second embodiment. FIG. 6 is a view showing the playback screen. The second embodiment is different from the first embodiment in that only notes are displayed. Other aspects are essentially the same as those of the first embodiment.

In Step S201, it is determined whether note display mode is selected by the user. In the note display mode, only notes are displayed. As shown in FIG. 6, a mark D1 for simultaneously displaying a series of reduced-size notes (i.e., note “thumbnails”), and a mark D2 for displaying the series of notes in order are displayed on the LCD monitor 24. The user selects by touching one of the marks D1 and D2.

While the note display mode has not been selected, the process goes to Step S202, in which the normal playback display process is carried out (S202 to S204), similarly to the first embodiment. On the other hand, if it is determined that the note display mode has been selected, the process goes to Step S205, in which it is determined whether the mark D1 has been touched, i.e., that the display method for displaying note thumbnails has been selected.

When it is determined that the mark D1 has been touched, the process goes to Step S207, in which note thumbnails are displayed (see FIG. 6). In the second embodiment, header information representing a note is added to an image file when recording the note. The image data for note screens is selected from a series of recorded image data on the basis of the header information. Herein, nine note thumbnails are displayed on the LCD 24 monitor simultaneously. The user can easily confirm the location of the photographed scenes, the photographing conditions, etc.

On the other hand, when it is determined that the mark D2 has been touched, i.e., that the slide display has been selected, the process goes to Step S206. In Step S206, a selected note screen is displayed on the LCD 24. Marks E1 and E2, marked on the LCD monitor 24, may be touched to change the displayed note. The user may advance the note display in reverse or forward order by touching the marks E1 and E2 (S208 and S209), respectively. Thus, the user may review notes one by one. In Step S201, it is determined whether the return to photographing mode has been commanded. If affirmative, the process is terminated.

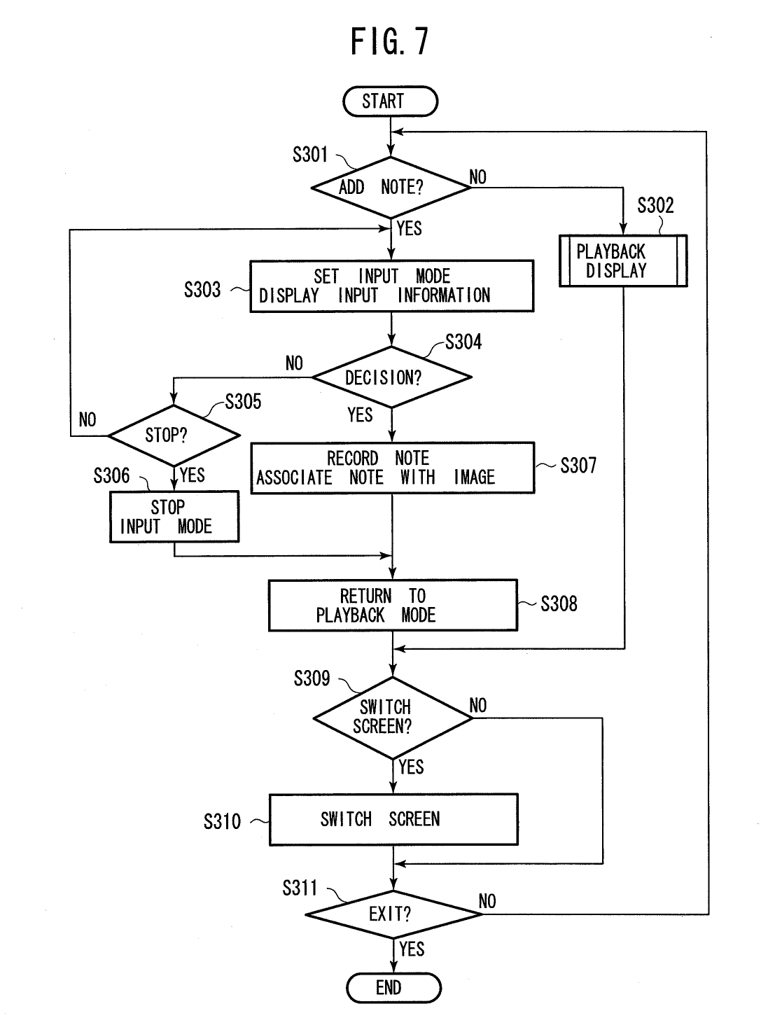

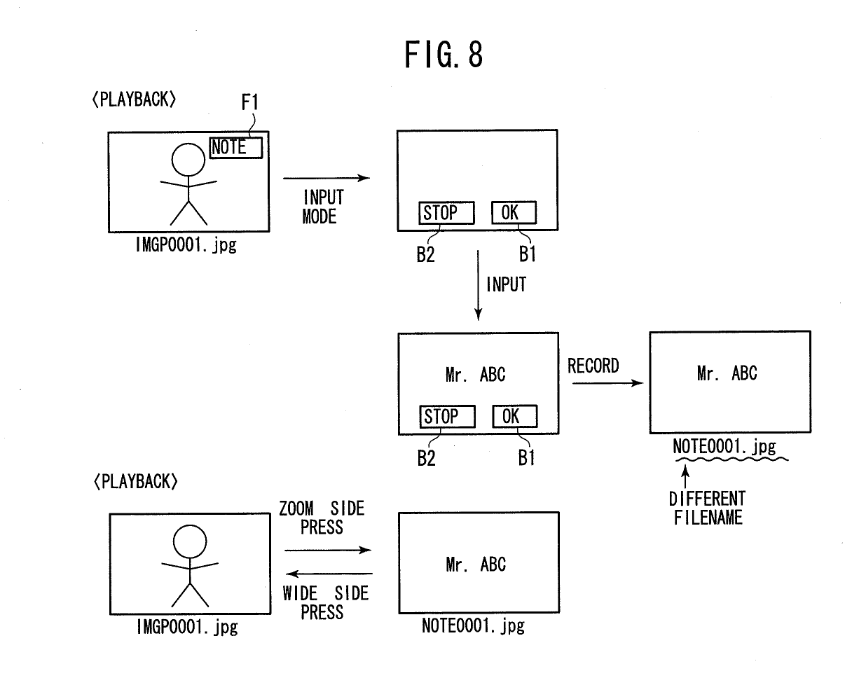

The third embodiment is explained with reference to FIGS. 7 and 8. In the third embodiment, a note can be input and recorded just after a photograph has been taken, and it is then associated with the photographic image. Furthermore, the note and associated photographic image are displayed alternately. Other aspects are the same as those of the first and second embodiments.

FIG. 7 is a flowchart of a playback process according to the third embodiment. FIG. 8 is a view showing the addition of a note and a playback display.

In Step S301, it is determined whether an operation for switching the playback mode to the input mode has been performed by the user. Herein, a mark F1 for changing the mode is displayed on the LCD 24 in the playback mode. When it is determined that the mark F1 has not been touched, the playback display process is carried out just in the first embodiment (S302). On the other hand, if it is determined that the mark F1 has been touched, the process goes to Step S303, wherein the input mode is set. Thus, characters or drawings input by the user are displayed on the LCD monitor 24 (see FIG. 8).

Steps S304 to S308 are the same as Steps S111 to S114 in the first embodiment. Namely, the note screen is recorded as image data by touching the mark B1. Note that in the third embodiment, a new filename is generated for the image data of the note. Namely, the header of the new image file will have a different name from that of the photographic image. In FIG. 8, the header name of the photographic image is given as “IMGP”, while the header name of the corresponding note is given as “NOTE”. In order to associate a photographic image with a corresponding note, the file number of the photographic image is chosen to be the same as that of the corresponding note. After the note is recorded, the process goes to Step S308, in which the playback mode is set.

In Step S309, it is determined whether an operation for switching a photographic image to a corresponding note has been performed by the user. In the third embodiment, a reproduced photographic image and an associated note can be displayed alternately (S310). The user switches screens by operating the zoom lever. The note screen is displayed by pushing the “zoom” side, whereas the photographic image is displayed by pushing the “wide” side (see FIG. 8). Thus, the user can instantly see the photographing location, the name of the target subject, etc., while viewing a photographic image. When the return to photographing mode is commanded, the process is terminated (S311).

The generation of a new file may be implemented in the second embodiment. Furthermore, the recording process above may also be implemented in the second embodiment. In this case, the note images may be displayed as an “index”, and one photographic image may be selected for display from a series of photographic images by touching the corresponding note thumbnail. In other words, by selecting one note from the series of notes, which are displayed simultaneously or in order, the photographic image associated with the selected note is displayed.

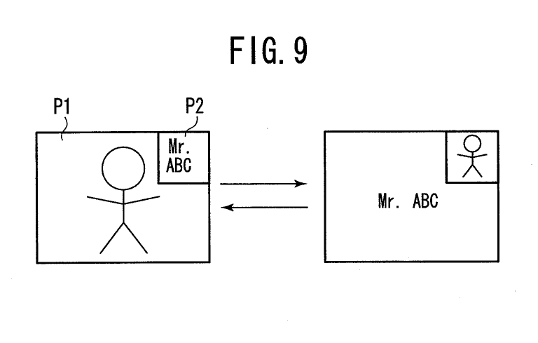

FIG. 9 is a view showing a playback screen according to the fourth embodiment. In the fourth embodiment, a photographic image and note are displayed in a parent screen and an inset child window, respectively, and may be switched by touch. Other aspects are the same as those of the third embodiment.

Similarly to the third embodiment, the new note is added and recorded during the playback mode. When the playback mode is set again, the photographic image is displayed in the parent screen P1, and the associated note screen is displayed in the child window P2. When the user touches the parent screen P2, the note screen is displayed in the parent screen and the photographic image is displayed in the child window. When the user touches the child window P2, the photographic image is displayed in the parent screen P1 and the note is displayed on the child window P2. Thus, the user can view a photographic image and a note at the same time.

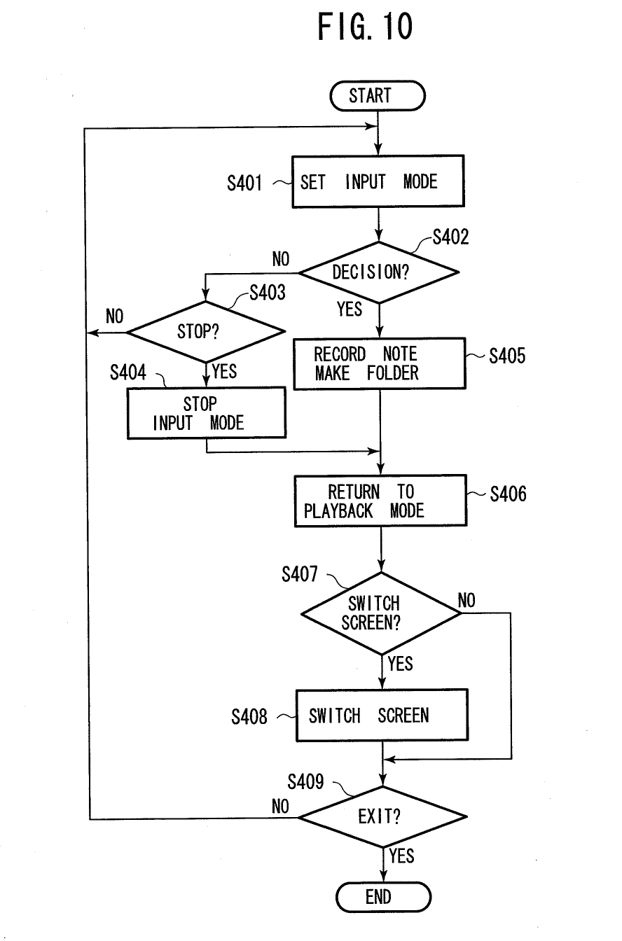

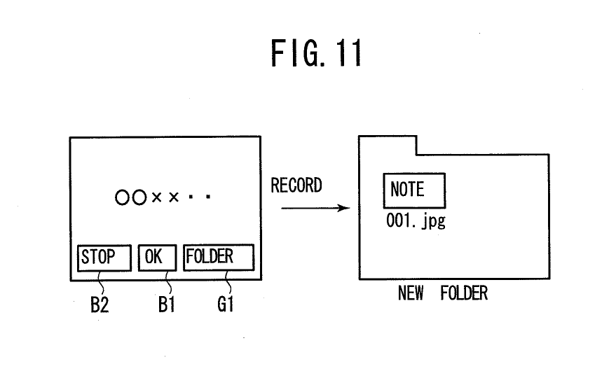

The fifth embodiment is explained with reference to FIGS. 10 and 11. In the fifth embodiment, a new folder is generated. Other aspects are the same as those of the third embodiment.

FIG. 10 is a flowchart of a playback process according to the fifth embodiment. FIG. 11 is a view showing a folder.

Steps S401 to S405 are substantially the same as Steps S303 to S307 in FIG. 7. Note that in Step S401, a mark G1 for making a folder is displayed on the LCD monitor 24 (See FIG. 11). Then, in Step S405, a new folder is generated with the recording of the note image if the mark G1 has been touched in Step S401. The recorded image data of the note is stored in the generated folder. Further, associated photographing image is also stored in the folder. Thus, a series of recorded notes can be searched easily.

Steps S406 to 409 in FIG. 10 are the same as Steps S308 to S311 in FIG. 7. Namely, a photographic image and an associated note are displayed alternately. The creation of a new folder, described above, may also be implemented in the second and third embodiments.

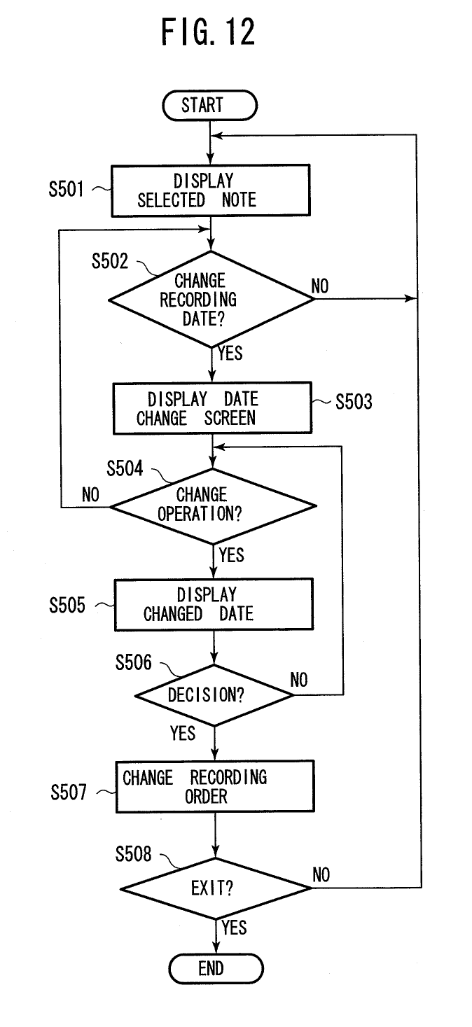

The sixth embodiment is explained with reference to FIGS. 12 to 14. In the sixth embodiment, the recording order of the note is changed. Other aspects are the same as in the first embodiment.

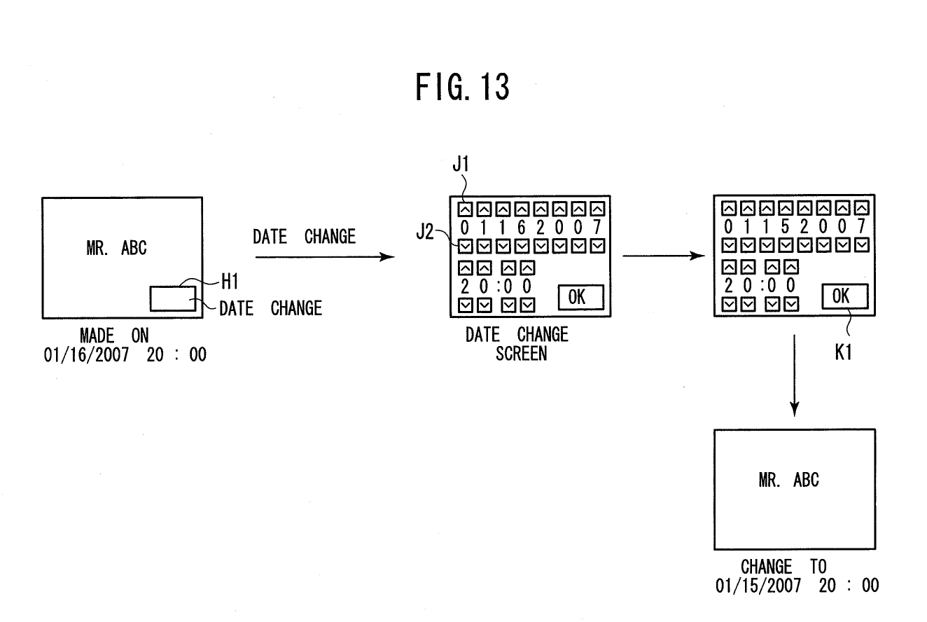

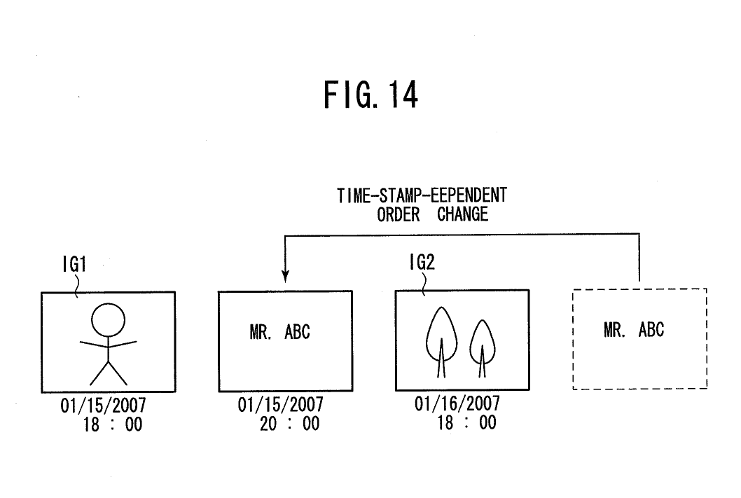

FIG. 12 is a flowchart of the recording order change process according to the sixth embodiment. FIG. 13 is a view showing the changing of a recorded note date. FIG. 14 is a view showing the recording order alternation of the playback images.

In Step S501, a selected note is displayed on the LCD 24 in the playback mode. Herein, a mark H1 for changing the recording date is displayed on the LCD monitor 24 (see FIG. 13). In Step S502, it is determined whether the mark H1 has been touched. When it is determined that the mark H1 has been touched, the process goes to Step S503, in which a screen for changing the recording date is displayed (see FIG. 13). In the date change screen, the recording day and time are shown in numerals. Allow marks J1 and J2, above and below each numeral, are displayed for increasing and decreasing the value of the numerals, respectively. When the user touches the allow marks J1 or J2, the value of numeral increases or decreases by 1, respectively.

In Step S504, it is determined whether the mark J1 or mark J2 has been touched. When it is determined that either the mark J1 or J2 has been touched, the value of the corresponding figure is changed, and the changed date is displayed on the LCD 24. For example, in FIG. 13, the numeral “16” (indicating the day) has been changed to “15”. In Step S506, it is determined whether the mark K1 for finalizing the date change has been touched. When the mark K1 has been touched, the process goes to Step S507, in which the recording order of the selected note may be changed. When the return to photographing mode is commanded (S508), the recording order change process is terminated.

As shown in FIG. 14, the note was recorded after two photographic images IG1 and IG2 were taken. By altering the date stamp of the note, the note is re-ordered to the position between the images IG1 and IG2. Thus, the note associated with the image IG1 will be displayed neighbor to the image IG1. Thus, the user can re-position any the recorded note to a desired position even if the note was recorded after a series of photographs was completed. Note that the process of folder creation illustrated in the fifth embodiment may be implemented in the sixth embodiment as well. In this case, specific photographed images are selected from a series of photographed images on the basis of the changed recording date. The selected photographed images are stored in the new folder.

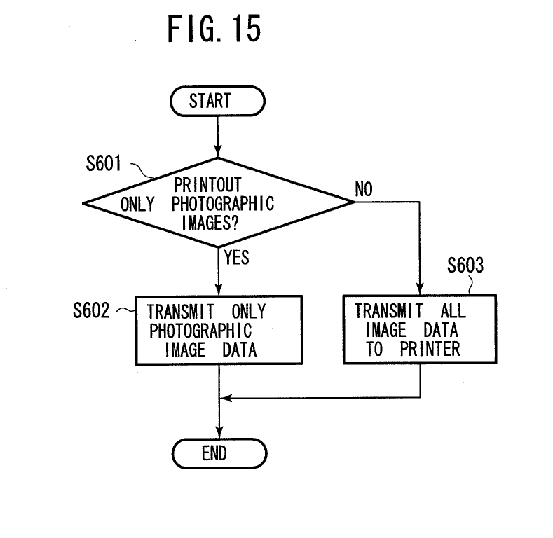

FIG. 15 is a flowchart of a print process according to the seventh embodiment. In the seventh embodiment, photographic images are printed out. Other aspects are the same as those of the first embodiment. Herein, a printer (not shown) is connected to the camera 10, and image data can be transmitted to the printer.

In Step S601, it is determined whether the user has selected a print method that ignores recorded notes and prints out only photographic images. In playback mode, a mark for printing out both the photographic images and notes, and a mark for printing out only the photographic images are displayed on the LCD monitor 24 (not shown). The user selects one of the two marks when carrying out a printing process.

When it is determined that both photographic images and notes should be printed out, the process goes to Step S603, in which all image data, including the photographic image and note screen data, is transmitted to the printer. On the other hand, if it is determined that only photographic images should be printed out, the process goes to Step S602, in which only the photographic image data is transmitted to the printer. Image data may also be transmitted to other peripheral equipment such as an external storage device, or a computer.

A note screen may be displayed in other colors other besides white. Photographic images and input screen images may be recorded without compression. An input device for a note other than the touch panel, such as a four-way controller, may instead be provided on the camera 10. Also, input information may be displayed by transmitting data from the computer to the camera via a cable or wirelessly. Furthermore, electronic equipment with a photographing function, such as cell phones, may be implemented instead of a camera.

Finally, it will be understood by those skilled in the arts that the foregoing description is of preferred embodiments of the device, and that various changes and modifications may be made to the present invention without departing from the spirit and scope thereof.

The present disclosure relates to subject matter contained in Japanese Patent Applications No. 2007-011964 (filed on Jan. 22, 2007), No. 2007-334951 (filed on Dec. 26, 2007), which are expressly incorporated herein by reference, in their entireties.

1. An apparatus for photographing comprising:
a photographing processor that carries out a photographing process;
a recording processor that records a photographic image;
a display processor that is capable of displaying a recorded photographic image, and displaying input information on an input information screen separately from the photographic image;
wherein said recording processor records the input information screen as an image, and said display processor displays the recorded input screen image.

2. The apparatus of claim 1, wherein said display processor displays a series of recorded input screen images and photographic images according to the recording order of the images.

3. The apparatus of claim 1, wherein said recording processor records input screen images and the photographic images by using a compressing process.

4. The apparatus of claim 1, further comprising an input device, said display processor displaying input information on the input information screen in accordance with an input operation.

5. The apparatus of claim 4, wherein said input device comprises a touch panel.

6. The apparatus of claim 1, further comprising a mode change processor that changes a photographing mode to an input mode, said display processor displaying the input information on the input information screen in the input mode.

7. The apparatus of claim 1, wherein said photographing processor carries out a process performed in a playback mode while the input information is displayed.

8. The apparatus of claim 1, wherein said display processor displays only recorded input information images simultaneously or sequentially.

9. The apparatus of claim 1, further comprising a mode change processor that changes a playback mode to an input mode, said recording processor associating an input information screen to be recorded with a photographic image on a screen, just before changing from the playback mode to the input mode, said display processor displaying the input information screen and the associated photographic image alternately.

10. The apparatus of claim 9, wherein said displaying processor displays an input information screen and a related photographic image in a child window and a parent screen, respectively, and switches between the child window and the parent screen.

11. The apparatus of claim 1, wherein said recording processor generates a folder that stores an input information screen when recording the input information screen.

12. The apparatus of claim 1, further comprising a recording order change processor that changes the recording order of recorded input information screens.

13. The apparatus of claim 1, further comprising a data-transmitting processor that transmits only the data of the photographic images to an external location.

14. A method for photographing comprising:
recording a photographic image;
displaying a recorded photographic image;
displaying input information on an input information screen separately from the photographic image;
recording the input information screen as an image; and
displaying the recorded input screen image.
